(19) United States
(12) Patent Application Publication
(10) Pub. No.: US 2013/0290057 A1
(43) Pub. Date: Oct. 31, 2013

(54) SYSTEM AND METHOD OF DEVICE MAINTENANCE REPORTING VIA A WIRELESS PROTOCOL

(71) Applicants: Kevin G. Piel, Ronkonkoma, NY (US); Michael Garavuso, Lindenhurst, NY (US); Lewin Aleksis Roger William Edwards, Sarasota, FL (US); Narine Boodoosingh, Ozone Park, NY (US); John Kovach, Shoreham, NY (US)

(72) Inventors: Kevin G. Piel, Ronkonkoma, NY (US); Michael Garavuso, Lindenhurst, NY (US); Lewin Aleksis Roger William Edwards, Sarasota, FL (US); Narine Boodoosingh, Ozone Park, NY (US); John Kovach, Shoreham, NY (US)

(73) Assignee: Honeywell International Inc., Morristown, NJ (US)

(21) Appl. No.: 13/458,589

(22) Filed: Apr. 27, 2012

(51) Int. Cl. G06Q 10/10; G08B 26/00

(52) U.S. Cl. 705/7.19; 340/505

(57) ABSTRACT

Systems and methods of device maintenance reporting via a wireless protocol are provided. Systems can include a central station and a plurality of remote systems such that the central station is in wireless bidirectional communication with each of the plurality of remote systems. When the central station receives a maintenance signal from a first of the plurality of remote systems, the central station can poll each of the plurality of remote systems located within a predetermined distance of a location of the first of the plurality of remote systems. The central station can also determine whether a maintenance need exists for each of the plurality of remote systems located within the predetermined distance.

### FIELD

The present invention relates generally to remote maintenance reporting and scheduling. More particularly, the present invention relates to systems and methods of device maintenance reporting via a wireless protocol.

### BACKGROUND

In known systems and methods, service personal must manually schedule appointments to perform service on or perform regular maintenance of a remote system. In some known systems and methods, a central station in connection with the remote system, for example, a wireless security system, can receive a signal from the remote system indicating that the system is in need of maintenance. For example, the system can transmit such a signal when there is a low battery, a smoke detector needs cleaning, and the like. Service personnel at the central station can schedule an appointment to service the remote system and then visit the site of the remote system at the scheduled appointment time.

This is a time consuming and cumbersome process. Furthermore, resources are not optimized, and the efficiency of security personnel is not maximized. For example, when service personnel visit a site to replace a low battery in one device, the service personnel might also need to replace batteries in additional system devices. In some cases, batteries might be changed, even though they are not low, in order to ensure that the service personnel will not need to visit the remote site for a prolonged period of time after the initial visit. Additionally, service personnel may subsequently make a return trip to the same area to service a second remote system because the service personnel did not know about the second remote system's upcoming need for maintenance when visiting the first remote system.

There is thus a continuing, ongoing need for improved systems and methods of remote system and device maintenance reporting and scheduling.

### BRIEF DESCRIPTION OF THE DRAWINGS

FIG. 1 is a flow diagram of a method in accordance with disclosed embodiments; and

FIG. 2 is a block diagram of a system for carrying out the method of FIG. 1 and others in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include systems and methods of device maintenance reporting via a wireless protocol. For example, before, during, or after service personnel are in the field performing maintenance on a remote system at a first site, systems and methods disclosed herein can maximize the efficiency of the service personnel by locating remote systems at other sites that require or will soon require maintenance. In some embodiments, systems and methods disclosed herein can find remote systems that require maintenance in accordance with different parameters, including, but not limited to, zip code, town, state, radius, and the like.

For example, before, during, or after a serviceman performs maintenance on a remote system in a first zip code, town, or state, systems and methods disclosed herein can determine if remote systems at a plurality of other sites in the same zip code, town, or state also require maintenance. Additionally or alternatively, systems and methods disclosed herein can determine if remote systems at a plurality of other sites within a predetermined radius or distance (in miles or kilometers) of the first site, zip code, town, or state require maintenance.

According to some embodiments, systems and methods disclosed herein can schedule appointments to service the remote systems in the plurality of other sites, as needed. For example, systems and methods disclosed herein can determine how many devices in each remote system at the plurality of other sites require service. Then, systems and methods disclosed herein can make an appropriate number of appointments given the time required to service each of the devices.

In some embodiments, systems and methods disclosed herein can prioritize and/or schedule appointments according to location. For example, systems and methods disclosed herein can access a mapping program to determine the most efficient driving route between service sites.

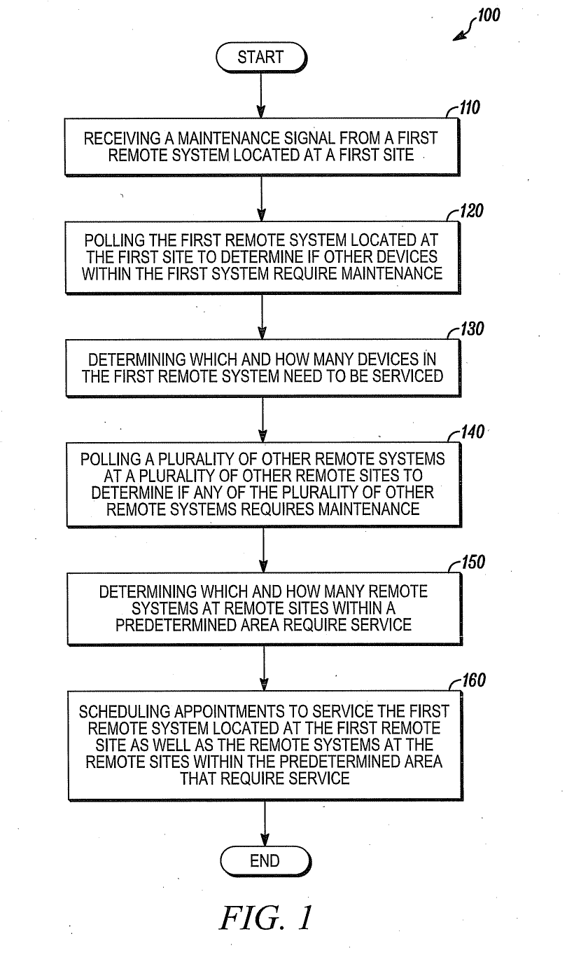

FIG. 1 is a flow diagram of a method 100 in accordance with disclosed embodiments. As seen in FIG. 1, the method 100 can include receiving a maintenance signal from a first remote system located at a first site as in 110. For example, the maintenance signal can be received at or by a central monitoring station and/or monitoring or communication device carried by a serviceman. In some embodiments, the central monitoring station can receive the maintenance signal and send a corresponding maintenance signal to a monitoring or communication device carried by a serviceman at the central monitoring station and/or in the field.

The maintenance signal can include information about a device in the first remote system that requires maintenance. For example, the maintenance signal can indicate that an alarm device at the front door of the first site has a low battery.

After receiving the maintenance signal as in 110, the method 100 can include polling the first remote system located at the first site to determine if other devices within the first system require maintenance as in 120. That is, the method 100 can proactively determine if other devices in the first remote system require maintenance.

For example, the method 100 can determine if other devices in the first remote system have or are close to a low battery. To determine if a device is close to having a low battery, the devices in the first remote system can be polled to determine the battery level of each device. Accordingly, the method 100 can determine if a device will have a low battery within a predetermined period of time, even though a low battery signal has not yet been sent for that device.

Based on the results of polling as in 120, the method 100 can include determining which and how many devices in the first remote system need to be serviced as in 130. For example, the method 100 can determine which of the other devices in the first remote system have batteries that should be changed. In some embodiments, the method 100 can determine that a battery should be changed if the battery level is at or below a predetermined level and thus, would likely need to be changed within a predetermined period of time, which would otherwise require another service call.

The method 100 can also include polling a plurality of other remote systems at a plurality of other sites to determine if any of the plurality of other remote systems requires maintenance as in 140. That is, the method 100 can proactively determine maintenance needs for a plurality of remote systems.

For example, the method 100 can poll systems that are located at sites within a predetermined area of the first site. In some embodiments, the predetermined area can be defined by parameters including, but not limited to, zip code, city, state, radius (in miles or kilometers), and the like.

Based on the results of the polling as in 140, the method 100 can include determining which and how many remote systems at the remote sites within the predetermined area require service 150. The method 100 can also include scheduling appointments to service the first remote system located at the first remote site as well as the remote systems at the remote sites within the predetermined area that require service as in 160. In some embodiments, the scheduled appointments can be made on the same day or on the same route to maximize the efficiency of the service personnel.

A real life scenario of the method 100 may involve a service person in the field with a set route and/or schedule of service appointments. The service person can carry a monitoring and/or communication device, for example, a cell phone, a personal computer, or a tablet computer, that can access mapping and live traffic data, such as through a proprietary program, for example, Google maps. Using his device, the service person can be automatically informed when a remote system that requires service is conveniently located to the service person's current route. Using his device, the service person can also be automatically informed when a remote system should be deleted from the service person's current route.

For example, a service person can be scheduled to go from location A to location B, then to location C, then to location D, and finally to location E. If the route from location B to location C is blocked by an accident or other road block, systems and methods disclosed herein can instruct the service person to remove location C from his route and continue to location D after leaving location B. Systems and methods disclosed herein can also notify a central monitoring station about the change in scheduling. Then, personnel at the central monitoring station can notify individuals at location C that the remote system at location C will be serviced on another day.

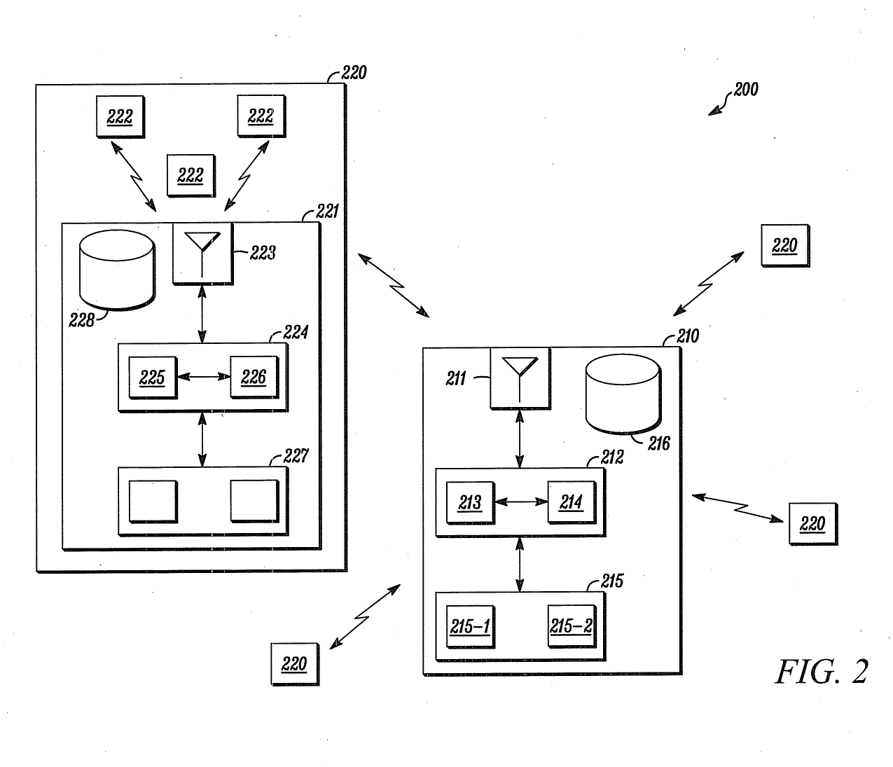

FIG. 2 is a block diagram of a system 200 for carrying out the method of FIG. 1 and others in accordance with disclosed embodiments. As seen in FIG. 2, the system 200 can include a central monitoring station 210 in wireless bidirectional communication with a plurality of remote systems 220, for example, security systems, at remote sites. It is to be understood that the central monitoring station 210 could also be a monitoring or communication device carried by service personnel and/or be in communication with a monitoring or communication device carried by service personnel.

The central station 210 can include a transceiver 211, control circuitry 212, one or more programmable processors 213, and executable control software 214 as would be understood by those of ordinary skill in the art. In some embodiments, the central monitoring station 210 can also include a user interface device 215, and a memory device 216, for example, a database or server.

The user interface device 215 can include a viewing screen 215-1, as would be known by those of skill in the art, and one or more user input mechanisms 215-2. In some embodiments, the viewing screen 215-1 can display interactive and viewing windows, and in some embodiments, the user interface device 215 can be a multi-dimensional graphical user interface. In some embodiments, the user input mechanisms 215-2 can include, for example, a keypad or a mouse, that can receive user input.

The executable control software 214 can implement the method 100 shown and described in FIG. 1 as well as others described herein. Further, the executable control software 214 can be stored on a transitory or non-transitory local computer readable medium, including, but not limited to, local computer memory, RAM, optical storage media, magnetic storage media, flash memory, and the like.

The transceiver 211 can include any type of transceiver that is capable of supporting the wireless bidirectional communication between the central station 210 and the plurality of remote systems 220. For example, the transceiver can support wireless protocols including, but not limited to, GSM, IP, and the like.

Each of the plurality of remote systems 220 can include a control panel 221 and a plurality of wireless devices 222, for example, smoke detectors or surveillance cameras. As seen in FIG. 2, the control panel 221 of each remote system 220 can include a transceiver 223, control circuitry 224, one or more programmable processors 225, executable control software 226, a user interface device 227, and a memory device 228.

Each control panel 221 can be in wireless bidirectional communication with the plurality of wireless devices 222 in the system 200 as well as with the central station 210. For example, the transceiver 223 can facilitate the communication between the control panel 221 and the devices 222 and between the control panel 221 and the central station 210. In some embodiments, the central station 210 can communicate directly with the plurality of wireless devices 222, absent the control panel 221.

As explained above, the communication between the remote systems 220, the central station 210, and/or monitoring or communication devices carried by service personnel can include bidirectional wireless communication. In some embodiments, the communication according to systems and methods disclosed herein can be supported by any wireless protocol as would be known by those of skill in the art, including but not limited to GSM, IP, and the like.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A method comprising:
receiving a maintenance signal from a first remote system located at a first remote location;
polling a plurality of other remote systems located at a plurality of respective remote locations;
a processor determining whether a maintenance need exists for each of the plurality of other remote systems;
the processor scheduling an appointment to service the first remote system; and
when the processor determines that the maintenance need exists for at least one of the plurality of other remote systems, the processor scheduling an appointment to service the at least one of the plurality of other remote systems,
wherein scheduling the appointment to service the first remote system and scheduling the appointment to service the at least one of the plurality of other remote systems includes scheduling the appointments according to respective locations of the first remote system and the at least one of the plurality of other remote systems.

2. The method of claim 1 wherein receiving the maintenance signal includes determining a first device in the first remote system that requires maintenance.

3. The method of claim 1 wherein polling the plurality of other remote systems includes polling a plurality of devices in the first remote system, and determining at least one of the plurality of devices in the first remote system that requires maintenance.

4. The method of claim 1 wherein the plurality of other remote systems includes at least a second remote system located at a second remote location.

5. The method of claim 4 wherein polling the plurality of other remote systems includes polling a plurality of devices in the second remote system, and determining at least one of the plurality of devices in the second remote system that requires maintenance.

6-8. (canceled)

9. A system comprising:
a transceiver;
a programmable processor; and
executable software stored on a non-transitory computer readable medium for:
receiving a maintenance signal from a first remote system located at a first remote location;
polling a plurality of other remote systems located at a plurality of respective remote locations;
determining whether a maintenance need exists for each of the first plurality of other remote systems;
scheduling an appointment to service the first remote system; and
when the maintenance need exists for at least one of the plurality of other remote systems, scheduling an appointment to service the at least one of the plurality of other remote systems,
wherein scheduling the appointment to service the first remote system and scheduling the appointment to service the at least one of the plurality of other remote systems includes scheduling the appointments according to respective locations of the first remote system and the at least one of the plurality of other remote systems.

10. The system of claim 9 wherein the transceiver facilitates bidirectional wireless communication via a wireless protocol.

11. The system of claim 10 wherein the wireless protocol is one of GSM and IP.

12. The system of claim 9 further comprising executable control software for determining a first device in the first remote system that requires maintenance.

13. The system of claim 9 further comprising executable control software for polling a plurality of devices in the first remote system, and determining at least one of the plurality of devices in the first remote system that requires maintenance.

14. The system of claim 9 wherein the plurality of other remote systems includes at least a second remote system located at a second remote location.

15. The system of claim 14 further comprising executable control software for polling a plurality of devices in the second remote system, and determining at least one of the plurality of devices in the second remote system that requires maintenance.

16-18. (canceled)

19. A system comprising:
a central station; and
a plurality of remote systems,
wherein the central station is in wireless bidirectional communication with each of the plurality of remote systems,
wherein, when the central station receives a maintenance signal from a first remote system in the plurality of remote systems, the central station polls each of the plurality of remote systems located within a predetermined distance of a location of the first remote system and determines whether a maintenance need exists for each of the plurality of remote systems located within the predetermined distance,
wherein the central station schedules an appointment to service the first remote system,
wherein, when a maintenance need exists for a second remote system in the plurality of remote systems, the central station schedules an appointment to service the second remote system, and
wherein, when the central station schedules the appointment to service the first remote system and the appointment to service the second remote system, the central station schedules the appointments according to respective locations of the first remote system and the second remote system.

20. (canceled)

21. The method of claim 1 wherein each of the plurality of respective remote locations is within a predetermined distance from the first remote location.

22. The method of claim 1 wherein each of the plurality of respective remote locations is located in or within a predetermined distance from at least one of a zip code, city, or state of the first remote location.

23. The system of claim 9 wherein each of the plurality of respective remote locations is within a predetermined distance from the first remote location.

24. The system of claim 9 wherein each of the plurality of respective remote locations is located in or within a predetermined distance from at least one of a zip code, city, or state of the first remote location.
